(19) United States
(12) Patent Application Publication
(10) Pub. No.: US 2005/0244049 A1
(43) Pub. Date: Nov. 3, 2005

(54) Apparatus and method for inspecting pattern on object

(75) Inventors: Hiroyuki Onishi, Kyoto (JP); Yasushi Sasa, Kyoto (JP); Manabu Tsujimura, Tokyo (JP); Toshifumi Kinba, Tokyo (JP); Katsuya Okumura, Tokyo (JP)

Correspondence Address: MCDERMOTT WILL & EMERY LLP, 600 13TH STREET, N.W., WASHINGTON, DC, 20005-3096, US

(73) Assignees: DAINIPPON SCREEN MFG.CO., LTD.; EBARA CORPORATION

(21) Appl. No.: 11/097,139

(22) Filed: Apr. 4, 2005

(30) Foreign Application Priority Data
Apr. 30, 2004 (JP) P2004-135054

(51) Int. Cl. G06K 9/00

(52) U.S. Cl. 382/141

(57) ABSTRACT

In a pattern inspection apparatus (1), an electron beam emission part (31) emits an electron beam onto a substrate (9) and an image acquisition part (33) detects electrons from the substrate (9) to acquire a grayscale inspection image of the substrate (9). A binary reference image generated from design data (81) is multivalued by a grayscale image generator (52) on the basis of a histogram of pixel values in the inspection image to generate a grayscale reference image. A comparator (53) compares the inspection image with the reference image. The pattern inspection apparatus (1) can thereby perform an inspection of a very small pattern on the substrate (9) on the basis of the design data (81).

### BACKGROUND OF THE INVENTION

1. Field of the Invention

The present invention relates to a technique for inspecting a pattern on an object on the basis of an image acquired by using an electron beam.

2. Description of the Background Art

In a field of inspecting a pattern on a semiconductor substrate, a printed circuit board or the like, a variety of inspection methods have been conventionally used. Japanese Examined Patent Application Laid Open Gazette No. 4-10565 (Document 1) and Patent Publication No. 2997161 (Document 2), for example, disclose a technique for inspecting a pattern with high accuracy by performing a rounding operation on a corner portion of the pattern in a binary reference image derived from design data to approximate the pattern shape of the image to a pattern which is actually formed and comparing the processed binary reference image with a binary inspection image.

On the other hand, recently, with miniaturization of patterns formed on a semiconductor substrate, a comparison check using a grayscale image has been performed in many cases. As such a technique, for example, Japanese Examined Patent Application Laid Open Gazette No. 4-69322 (Document 3) discloses a technique for comparing a grayscale inspection image with a grayscale reference image which is obtained by converting a value of each pixel in a binary reference image derived from design data into a value acquired by taking a weighted average of values of neighboring pixels with a predetermined weighting factors added thereto. Japanese Patent Application Laid Open Gazette No. 2000-199709 (Document 4) suggests a technique for generating a grayscale reference image by acquiring a pseudo multivalued parameter (a representative value and a variance of pixel values) from a histogram of pixel values in a grayscale inspection image and adding characteristics of normal distribution on the basis of the pseudo multivalued parameter to a value of each pixel in a binary reference image derived from design data. Japanese Patent Application Laid Open Gazette No. 2002-107309 (Document 5) discloses an inspection technique for comparing an inspection image with a grayscale reference image approximate to an optical image, which is generated by obtaining a complex transmittance distribution or a complex reflectance distribution of a substrate from design data.

Japanese Patent Application Laid Open Gazette No. 2003-65969 (Document 6) suggests a technique for comparison check of an inspection image and a reference image, where a pixel value range derived from a cumulative histogram of pixel values in the reference image is adjusted to a pixel value range defined by an upper limit value and a lower limit value derived from a cumulative histogram of pixel values in the inspection image, to thereby approximate a histogram of pixel values in the reference image to that of pixel values in the inspection image. Japanese Patent Application Laid Open Gazette No. 2002-71330 (Document 7) discloses a technique for inspecting a pattern, where an exposure mask is two-dimensionally scanned with an electron beam to acquire a signal indicating a pattern and the signal is compared with a signal acquired from design data.

There is a case, however, where a lower-layer pattern is included in an inspection image acquired by optically picking up an image of a semiconductor substrate or the like on which a multilayer film is formed, and in such a case, if a comparison check shown in Documents 3 to 5 where a grayscale reference image is generated from design data is performed, the inspection image does not coincide with the reference image and it is not therefore possible to achieve a pattern inspection with high accuracy.

In other words, in a pattern inspection for a semiconductor substrate (wafer) of multilayer film structure, though only a surface layer should be observed, an optical inspection apparatus or observation apparatus is susceptible to an influence of underlayer and patterns in lower layers appear in sight through. For this reason, both the patterns in upper and lower layers appear on the same image, and it therefore becomes hard to detect a geometric defect in pattern by comparison with a reference image representing only a surface layer. On the other hand, since an inspection apparatus or observation apparatus using an electron ray is not susceptible to an influence of underlayer and can acquire an image representing a pattern on a surface layer, this is suitable for a pattern inspection of a wafer on which a multilayer film is formed.

In comparison between the optical inspection apparatus or observation apparatus and the inspection apparatus or observation apparatus using an electron ray, the inspection apparatus or observation apparatus using an electron ray can observe a relatively thinner film. For example, the optical inspection apparatus is thought to observe a film having a thickness of up to about 20 nm while the inspection apparatus using an electron ray is confirmed to observe even a film having a thickness of 5 nm. The demerit of the optical inspection apparatus or observation apparatus that can not observe a very thin film is caused by a fact that the apparatus uses light of wavelength generally ranging from 400 nm to 800 nm. With such a wavelength, it is hard to observe a surface of a film having a thickness not more than 40 to 50 nm, which is relatively thinner than the wavelength of light. On the other hand, the inspection apparatus or observation apparatus using an electron ray has no such a problem and can observe a film having a thickness of 5 nm.

The optical inspection apparatus or observation apparatus further causes a change in color depending on a film thickness. Specifically, the optical apparatus has an effect of film thickness of a layer close to the surface and changes the color to be observed when there is a difference in film thickness. Since the film thickness of a surface layer of a wafer is not necessarily constant, an acquired image has an effect of film thickness depending on the surface layer of the wafer. The reason is that when a wafer on which a film having a thickness about as much as the wavelength of light is formed is observed, the color of its surface is changed since an interference color appears due to the interference action of light. On the other hand, the inspection apparatus or observation apparatus using an electron ray is not susceptible to an effect of film thickness and does not change the color even if there is a difference in film thickness, thereby producing no effect on the acquired image.

Thus, the inspection apparatus or observation apparatus using an electron ray, which has no demerit of the optical apparatus as discussed above, is not susceptible to the underlayer, can observe a relatively thinner film and does not change the color to be observed depending on the film thickness. The optical apparatus has a resolution of about 150 nm at most while the inspection apparatus or observation apparatus using an electron ray has a resolution of 50 nm or higher resolution. Having a resolution at least three times or more, the apparatus using an electron ray is suitable for responding to miniaturization of patterns in the future.

Though the technique of Document 7 can acquire a signal representing a very small pattern on an uppermost surface of a substrate by using an electron beam, it is hard to perform a pattern inspection with high accuracy because of comparison using binary data.

### SUMMARY OF THE INVENTION

The present invention is intended for an apparatus for inspecting a pattern on an object, and it is an object of the present invention to perform an inspection of a very small pattern on the object on the basis of design data with high accuracy.

According to an aspect of the present invention, the apparatus comprises an electron beam emission part for emitting an electron beam with which an object is irradiated; an image acquisition part for acquiring a grayscale inspection image of an object by detecting electrons from the object; a storage part for storing design data of a pattern formed on an object; an image generation part for generating a grayscale reference image on the basis of the design data; and a comparator for comparing a grayscale inspection image acquired by the image acquisition part with a grayscale reference image generated by the image generation part.

By using an electron beam, it is possible to perform an inspection of a very small pattern on the object on the basis of design data with high accuracy.

Preferably, the electron beam emission part emits an electron beam onto the whole image pickup area on an object, and the image acquisition part comprises an optical system for forming an image with an electron beam from the image pickup area; and an image pickup part for picking up an electron image at a position where an image is formed by the optical system to acquire the grayscale inspection image. It is thereby possible to acquire the inspection image at a high speed.

According to one preferred embodiment of the present invention, the image generation part generates the grayscale reference image by multivaluing a binary reference image derived from the design data on the basis of a histogram of pixel values of the grayscale inspection image. It is thereby possible to generate the grayscale reference image adjusted to the inspection image.

Further, the present invention is especially suitable for an inspection of a pattern on a semiconductor substrate on which a multilayer film is formed.

The present invention is also intended for a method of inspecting a pattern on an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a pattern inspection apparatus;

FIG. 2 is a view simply showing an image pickup plane of a TDI line camera;

FIG. 3 is a view showing a prescan image;

FIG. 4 is a graph showing a histogram of pixel values of the prescan image;

FIG. 5 is a flowchart showing an operation flow for preparing a binary reference image;

FIG. 6 is a view showing a pattern indicated by design data;

FIG. 7 is a view showing a pattern after a rounding operation;

FIG. 8 is a flowchart showing an operation flow for inspecting a pattern on a substrate;

FIG. 9 is a view showing an inspection image;

FIG. 10 is a flowchart showing an operation flow for generating a grayscale reference image;

FIG. 11 is a view showing a binary reference image;

FIG. 12 is a view showing an intermediate image;

FIG. 13 is a view showing a grayscale reference image; and

FIG. 14 is a view showing a defect image.

### DESCRIPTION OF THE PREFERRED EMBODIMENTS

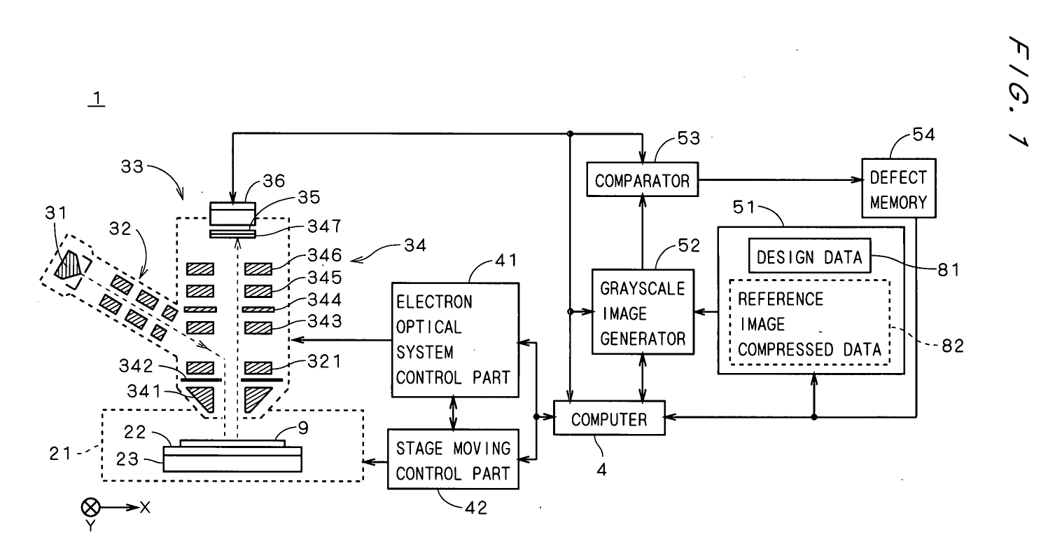

FIG. 1 is a view showing a construction of a pattern inspection apparatus 1 in accordance with one preferred embodiment of the present invention. The pattern inspection apparatus 1 comprises a stage 22 provided inside a chamber body 21 whose pressure is reduced by a not-shown pump, for holding a semiconductor substrate (hereinafter, referred to as “substrate”) 9 on which a multilayer film is formed, a stage moving mechanism 23 for moving the stage 22 in X and Y directions of FIG. 1, an electron beam emission part 31 for emitting an electron beam, a first optical system 32 for guiding the electron beam from the electron beam emission part 31 to the substrate 9, and an image acquisition part 33 for acquiring a grayscale inspection image of the substrate 9 by detecting secondary electrons or reflected electrons from the substrate 9. The image acquisition part 33 has a second optical system 34 for forming an image with an electron beam from a very small image pickup area on the substrate 9, a luminous part (fluorescent plate) 35 for causing luminescence in accordance with the image by receiving the electron beam at a position where the image in the image pickup area is formed by the second optical system 34, and a line camera of TDI (Time Delay Integration) system (hereinafter, referred to as “TDI line camera”) 36 for acquiring an inspection image by picking up an image of the luminous part 35. Though the luminous part 35 and the TDI line camera 36 are provided as an image pickup part for picking up an electron image in the pattern inspection apparatus 1, the image pickup part may be provided as an element for directly picking up an electron image.

The pattern inspection apparatus 1 further has an electron optical system control part 41 for performing an voltage control on electron optical systems in the first optical system 32 and the second optical system 34 and a stage moving control part 42 for controlling movement of the stage moving mechanism 23, and with the control by the electron optical system control part 41, the first optical system 32 guides the electron beam from the electron beam emission part 31 to the image pickup area on the substrate 9 and the second optical system 34 forms an image of the image pickup area in the luminous part 35, and the first optical system 32 and the second optical system 34 serve as an optical system of projection mapping (imaging) system.

Specifically, when an electron beam is emitted from the electron beam emission part 31 (hereinafter, the electron beam from the electron beam emission part 31 is referred to as a “primary electron beam”), the primary electron beam is guided to a Wien filter 321 by a group of lenses in the first optical system 32, and with its orbit turned by a deflection effect of the Wien filter 321, the primary electron beam is entirely emitted (in other words, the primary electron beam is emitted in a form of plane electron beam) to the whole of the very small image pickup area on the substrate 9 through an aperture part 342 and a cathode lens 341. When the primary electron beam is emitted onto the substrate 9, secondary electrons or reflected electrons are generated from the image pickup area on the substrate 9 and the electrons are guided as a secondary electron beam to the aperture part 342 by the cathode lens 341 in the second optical system 34. The secondary electron beam going through the aperture part 342 is guided to a microchannel plate 347 through the Wien filter 321, a lens 343, a field aperture part 344 and lenses 345 and 346. The secondary electron beam is amplified by the microchannel plate 347 and emitted to the luminous part 35 which is a fluorescence screen. Then, the TDI line camera 36 picks up an image of the luminous part 35 which causes luminescence in accordance with the image of the image pickup area which is formed with the secondary electron beam, and it is thereby possible to quickly acquire an inspection image by using the electron beam in a plane form which is collectively emitted to the image pickup area.

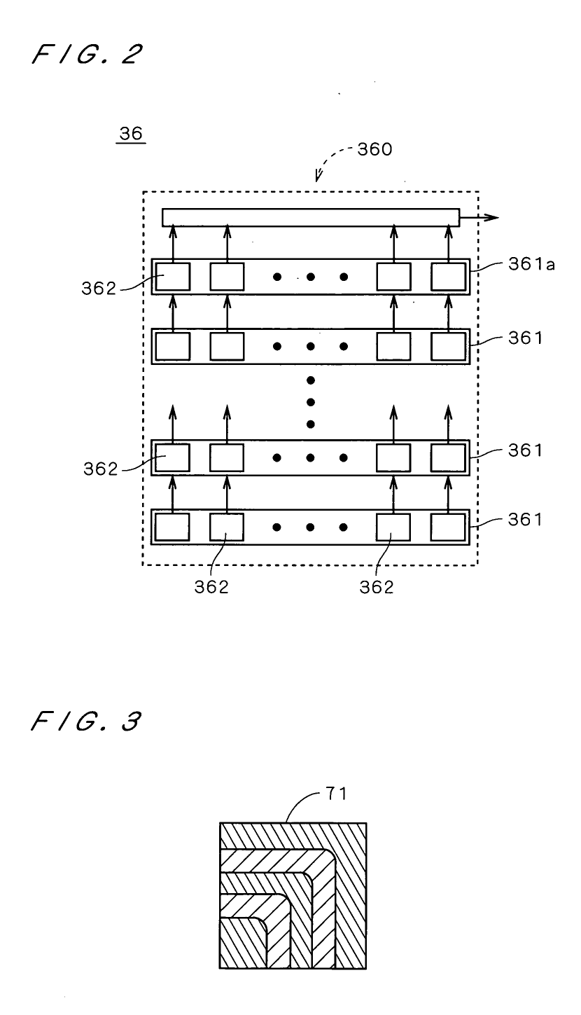

FIG. 2 is a view simply showing an image pickup plane 360 of the TDI line camera 36. The TDI line camera 36 has a plurality of line sensors 361 which are arranged in a direction perpendicular to the line, and electrons accumulated in each light receiving element 362 of each line sensor 361 are transmitted to the corresponding light receiving element 362 of the adjacent line sensor 361 at a predetermined timing and electrons accumulated in the lowermost line sensor 361a are sequentially outputted.

When an image is picked up by the TDI line camera 36, the substrate 9 is moved by the stage moving mechanism 23 in a direction corresponding to the transmission direction of electrons among the line sensors 361. At this time, the electrons in each light receiving element 362 of each line sensor 361 are transmitted at the same speed as the image of the luminous part 35 (i.e., the image of the image pickup area) formed on the image pickup plane 360 of the TDI line camera 36 is moved. Therefore, discussing with respect to one light receiving element 362, the electrons are transmitted at the same time as a very small image on the light receiving element 362 is moved onto the adjacent light receiving element 362, and the electrons accumulated in parallel with movement of the image of the image pickup area are outputted from the lowermost line sensor 361a in a sufficient amount. Then, an image of an inspection area on the substrate 9 where the image pickup area passes is acquired as a grayscale inspection image with a reading resolution of the TDI line camera 36.

The pattern inspection apparatus 1 of FIG. 1 further comprises a storage part 51 for storing design data 81 which is CAD data representing a pattern formed on the substrate 9, a grayscale image generator 52 for generating a grayscale reference image on the basis of parameters for generation of a grayscale image as discussed later, a comparator 53 for comparing an inspection image acquired by the image acquisition part 33 with the reference image, a defect memory 54 for receiving data of an image representing a defect(s) which is a result of the comparison performed by the comparator 53, and a computer 4 constituted of a CPU for performing various computations, a memory for storing various pieces of information and the like. The computer 4 serves as a control part for controlling these constituent elements in the pattern inspection apparatus 1. The grayscale image generator 52 and the comparator 53 may be attached to the computer 4 as an expansion board, and the memory and storage device included in the computer 4 may serve as the storage part 51 and the defect memory 54.

Next, discussion will be made on two operations which are performed as preparation in advance for a pattern inspection by the pattern inspection apparatus 1. As the preparation for the pattern inspection, an operation for acquiring parameters for generation of a grayscale image and that for preparing a binary reference image are performed and hereafter, these operations will be discussed in this order.

In acquiring parameters for generation of a grayscale image, first, an image of part of an inspection area on the substrate 9 is picked up (in other words, prescanned) by the TDI line camera 36 in synchronization with the operation of the stage moving mechanism 23, and as shown in FIG. 3, a prescan image 71 which is part of the inspection image is acquired. An actual prescan image represents a pattern more complex than that shown in FIG. 3. The prescan image 71 is inputted to the computer 4, where a histogram of pixel values in the prescan image 71 is generated.

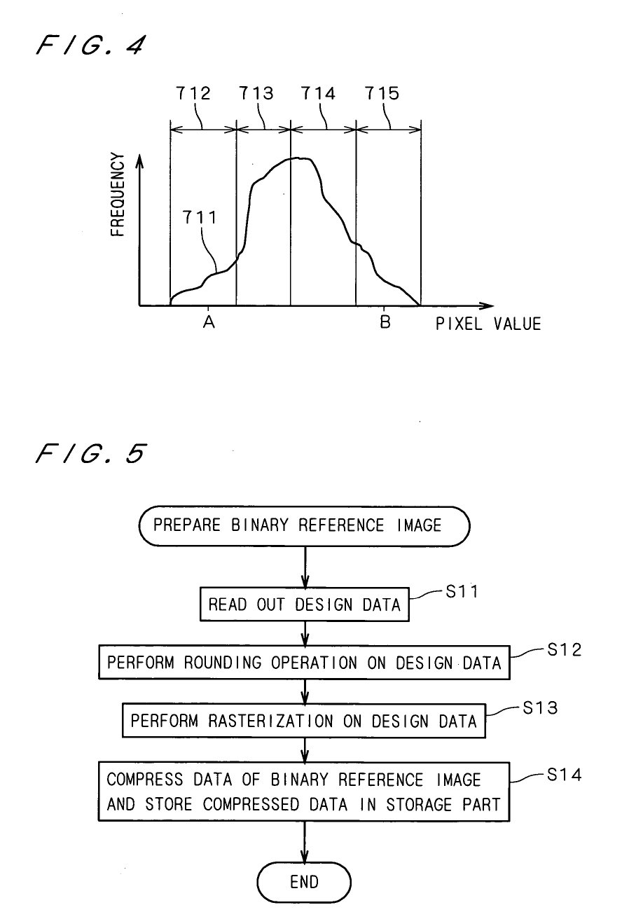

FIG. 4 is a graph showing a histogram 711 of pixel values in the prescan image 71. The computer 4 sets, e.g., four pixel value ranges corresponding to a wiring pattern and its background in an area dense with patterns and a wiring pattern and its background in an area sparse with patterns. As a method of obtaining a plurality of pixel value ranges, a variety of methods may be used, and for example, a method disclosed in “A Threshold Selection Method from Gray-Level Histograms” by Nobuyuki OTSU (IEEE TRANSACTIONS ON SYSTEMS, MAN, AND CYBERNETICS, VOL. SMC-9, No. 1, January 1979, pp. 62-66) may be used and the disclosure of which is herein incorporated by reference. In this method, as a value for evaluation on propriety of a threshold value, measures of class separability based on within-class variance and between-class variance (herein, “class” refers to a group of pixel values which are divided by the threshold value) are adopted, and a threshold value is obtained so that the measures of class separability can be the maximum. By this method, when an image is divided into a plurality of regions, it is possible to steadily obtain an optimum threshold value(s) in a non-parametric manner.

In the histogram 711 of FIG. 4, four pixel value ranges represented by reference numerals 712, 713, 714 and 715 are set. Subsequently, out of the four pixel value ranges 712 to 715, the darkest pixel value range 712 (on the side of smaller pixel values) and the brightest pixel value range 715 (on the side of larger pixel values) are selected, and the respective mean values of the pixel values included in the two pixel value ranges 712 and 715 are calculated (in FIG. 4, the two mean values are represented as A and B). The calculated two mean values A and B are outputted to the grayscale image generator 52 as parameters for generation of a grayscale image which is used in a pattern inspection process as discussed later.

Thus, in the pattern inspection apparatus 1, a plurality of pixel value ranges are set by the computer 4 on the basis of the histogram of the pixel values in the inspection image in the preparation process in advance, and the mean values of the two pixel value ranges corresponding to both ends of the histogram are acquired as parameters for generation of a grayscale image. The parameter may be a value other than the mean value of the pixel value range and may be other representative value such as a median of the pixel values in the range.

Next, the other operation for preparing a binary reference image which is performed as preparation will be discussed. FIG. 5 is a flowchart showing an operation flow for preparing a binary reference image.

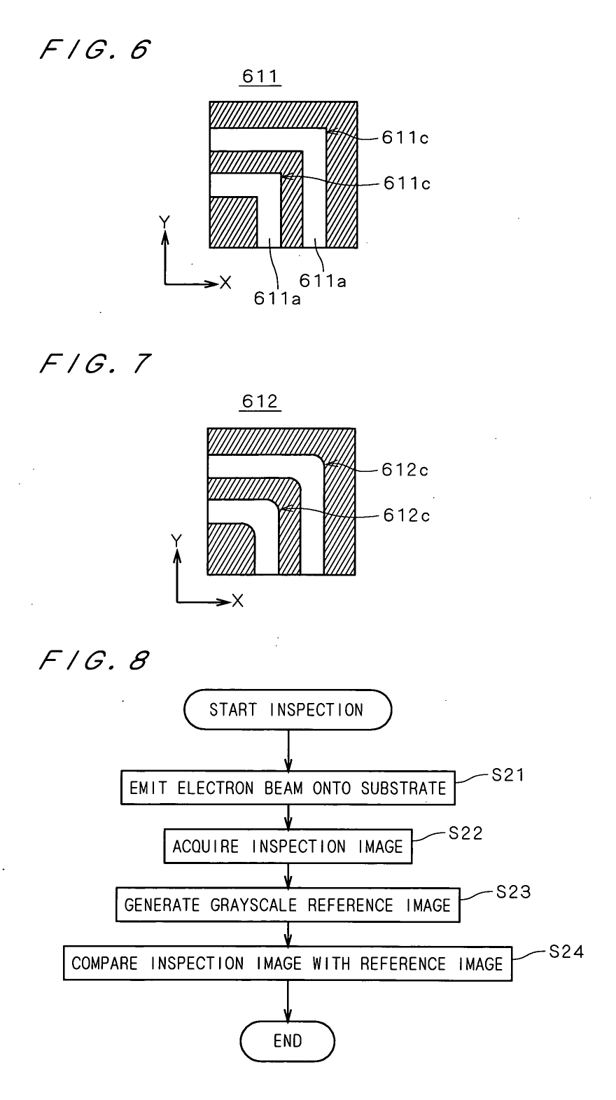

In preparing a binary reference image, first, the design data 81 stored in the storage part 51 is read out to the computer 4 (Step S11). FIG. 6 is a view showing part of a pattern 611 indicated by the design data 81. FIG. 6 shows two wiring patterns 611a bent at corner portions 611c, and the design data 81 indicates such a pattern 611 in a form of vector data. The computer 4 performs processing of the design data 81 so that the corner portions 611c of the wiring patterns 611a should be rounded (a rounding operation) (Step S12), and data indicating a pattern 612 after the rounding operation, which has rounded corner portions 612c as shown in FIG. 7, is acquired in a form of vector data.

Subsequently, the design data indicating the pattern 612 is rasterized, and a binary reference image indicating the pattern 612 and its background is generated in a form of raster data (Step S13). At this time, the binary reference image is generated with a resolution finer than the reading resolution of the image acquisition part 33. Specifically, the size of an area on the substrate 9 which corresponds to one pixel in the binary reference image is made sufficiently smaller than an area on the substrate 9 which corresponds to one pixel in the inspection image acquired by the image acquisition part 33 (e.g., an area of ¼ or less). Data of the binary reference image is compressed into a form of e.g., run-length data and outputted to the storage part 51, where the data is stored as reference image compressed data 82 (indicated by a broken-line rectangle in FIG. 1) (Step S14). Naturally, the data of the binary reference image may be compressed into a form other than the run-length data.

The above preparation is performed as necessary. For example, the operation for acquiring parameters for generation of a grayscale image is performed every time when the substrate 9 to be inspected is changed and the operation for preparing a binary reference image is performed only when a pattern of new shape is inspected.

When the preparation is completed, the pattern inspection apparatus 1 performs an operation for inspecting a pattern on the substrate 9. FIG. 8 is a flowchart showing an operation flow of the pattern inspection apparatus 1 for inspecting a pattern on the substrate 9.

In the pattern inspection apparatus 1, first, an operation of moving the substrate 9 starts while the electron beam emission part 31 starts emission of the primary electron beam onto the substrate 9 (Step S21). The secondary electron beam from the image pickup area on the moving substrate 9 is guided to the luminous part 35, and the TDI line camera 36 picks up an image of the luminous part 35 in synchronization with the operation of the stage moving mechanism 23, to thereby acquire a grayscale inspection image on the substrate 9 with a predetermined reading resolution (Step S22).

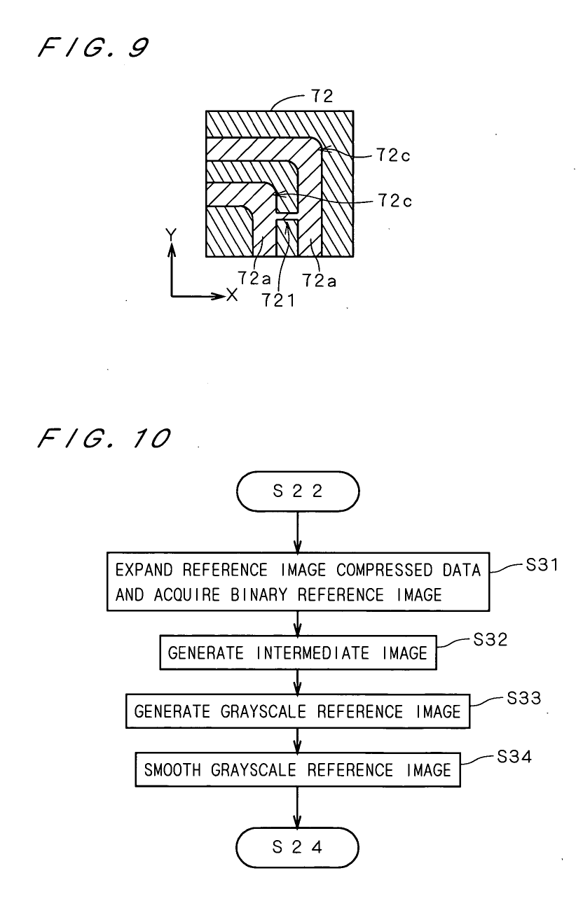

FIG. 9 is a view showing part of the acquired inspection image 72. The inspection image 72 of FIG. 9 indicates two wiring patterns 72a (for example, each having a line width of 100 nm) which are bent at corner portions 72c, and there arises a defect 721 which causes a short circuit between the two wirings on the (−Y) side of the corner portions 72c. The pixel values of the inspection image 72 acquired by the TDI line camera 36 are sequentially outputted to the comparator 53 and the grayscale image generator 52.

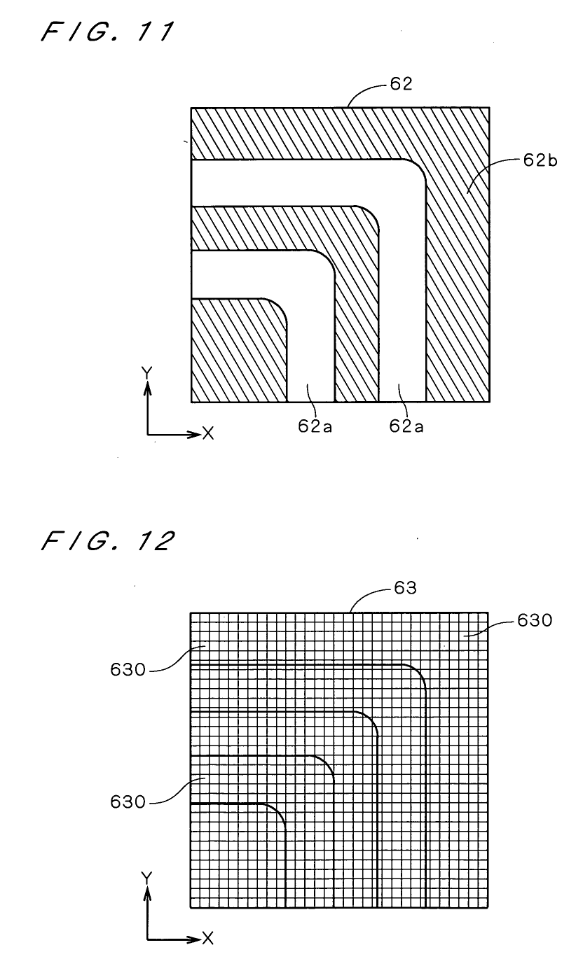

On the other hand, in parallel with Step S22, the grayscale image generator 52 generates a grayscale reference image from the binary reference image stored in the storage part 51 almost in synchronization with the acquisition of the inspection image 72 (Step S23). FIG. 10 is a flowchart showing an operation flow for generating the grayscale reference image in Step S23 of FIG. 8. In generating the grayscale reference image, first, the reference image compressed data 82 are sequentially outputted from the storage part 51 to the grayscale image generator 52 and expanded by a dedicated electric circuit included in the grayscale image generator 52 in real time, and a binary reference images 62 of FIG. 11 are thereby sequentially acquired in a form of raster data (e.g., for each line) (Step S31). In the binary reference image 62 of FIG. 11, it is assumed that a pixel value of 0 is given to a background portion 62b and a pixel value of 1 is given to a wiring pattern 62a. Though the operation discussed below is, actually, performed every time when several lines of the binary reference image 62 are expanded into raster data, discussion will be made assuming that it is performed for the whole of the image, for easy understanding.

After the binary reference image 62 is prepared, the pixel value of 0 for the background portion 62b and the pixel value of 1 for the wiring pattern 62a are converted into the mean values A and B of the two pixel value ranges 712 and 715 which are acquired in the preparation process, respectively, and an intermediate image is thereby generated (Step S32). The intermediate image is divided into a plurality of divided areas.

FIG. 12 is a view showing part of the intermediate image 63 which are divided into a plurality of divided areas 630. In FIG. 12, hatching which represents difference in pixel value is omitted. Herein, the intermediate image 63 is divided in accordance with the reading resolution for acquisition of the inspection image 72. Specifically, the size of an area on the substrate 9 corresponding to one divided area 630 of the intermediate image 63 is equal to the size of an area on the substrate 9 which corresponds to one pixel in the inspection image 72. The grayscale image generator 52 obtains a mean value of a plurality of pixel values included in each divided area 630, replaces each divided area 630 with one pixel having the mean value as its pixel value (i.e., sampling), and thereby generates a grayscale reference image (Step S33).

FIG. 13 is a view showing part of the grayscale reference image 64 which is thus generated. In FIG. 13, in principle, each pixel value of the background portion 64b is A and that of the wiring pattern 64a is B. Each pixel value in a portion in the vicinity of the boundary between the background portion 64b and the wiring pattern 64a is a mean value of a plurality of pixel values included in the divided area 630 which corresponds to the pixel and is replaced with a pixel value between A and B.

The grayscale image generator 52 uses a smoothing filter (low-pass filter) such as a Gaussian filter for the grayscale reference image 64 in accordance with change in pixel value in a direction perpendicular to an edge of a wiring pattern in the inspection image 72 (actually, the prescan image) of FIG. 9, to smooth the grayscale reference image 64 (Step S34). Specifically, when the pixel value in the inspection image 72 changes gently in the direction perpendicular to an edge, a smoothing filter for smoothing in a larger degree is used as compared with a case of sharp change. This approximates the change in pixel value in the vicinity of the edges of the wiring patterns 64a in the reference image 64 to those in the inspection image 72. The pixel values in the smoothed grayscale reference image 64 are outputted to the comparator 53. Thus, with the operation for acquiring the parameters for generation of a grayscale image by the computer 4 in preparation in advance and the operation of the grayscale image generator 52 in the pattern inspection, the appropriate grayscale reference image 64 in accordance with the characteristics of the inspection image 72 can be easily generated on the basis of the design data 81.

As discussed earlier, actually, Step S22 and Step S23 of FIG. 8 are executed in parallel in the pattern inspection apparatus 1. Specifically, the pixel values in the inspection image 72 are sequentially acquired by the image acquisition part 33 while the pixel values in the grayscale reference image 64 are sequentially generated by the grayscale image generator 52, and the pixel values in the inspection image 72 and those in the reference image 64 are sequentially inputted to the comparator 53.

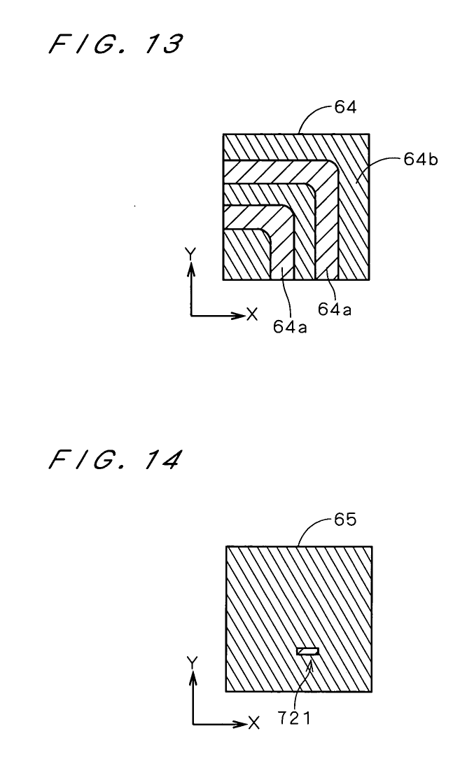

The comparator 53 compares each pixel value in the inspection image 72 with the corresponding pixel value in the grayscale reference image 64, to generate a defect image 65 specifying the defect 721 in the inspection image 72 as shown in FIG. 14 (Step S24 in FIG. 5). The comparator 53 acquires characteristics values indicating the area of the defect or the like from the defect image 65 as necessary and stores the values as defect information together with the defect image 65 into the defect memory 54. The defect information such as the defect image 65 is displayed on a display part of the computer 4 as necessary.

Thus, in the pattern inspection apparatus 1 of FIG. 1, an electron beam is emitted onto the substrate 9 and the secondary electrons or reflected electrons are detected, and the inspection image 72 representing a very small pattern on the substrate is thereby acquired. Then, the grayscale reference image 64 is generated by multivaluing the binary reference image derived from the design data 81 on the basis of the histogram 711 of the pixel values in the inspection image 72, and the inspection image 72 is compared with the reference image 64 to inspect the pattern on the substrate 9. The pattern inspection apparatus 1 can thereby inspect a very small pattern on the substrate 9 on the basis of the design data 81. Since the grayscale inspection image 72 on the substrate 9 is acquired by detecting the secondary electrons or reflected electrons from the substrate 9 irradiated with the electron beam, even in a case of inspection for a semiconductor substrate of multilayer film structure, it is possible to appropriately inspect a pattern without an effect of patterns on lower layers.

In Step S33, a pixel value in the grayscale reference image 64 is not necessarily a mean value of a plurality of pixel values included in the corresponding divided area 630, and for example, it may be a value determined in accordance with the number of pixels having the pixel value A or the pixel value B included in the divided area 630. Each divided area 630 in the intermediate image 63 may be converted into an area consisting of two or more pixels having the same value, instead of sampling into one pixel in the grayscale reference image 64. In other words, in the grayscale image generator 52, the intermediate image 63 is divided into a plurality of divided areas 630 and a plurality of pixel values included in each divided area 630 is substantially replaced with one pixel value which is obtained from the pixel values.

In the pattern inspection apparatus 1, if the storage part 51 is a mass and fast memory device (e.g., a hard disk device), it is possible to perform a quick pattern inspection by storing the grayscale reference image 64 which is generated in advance into the storage part 51, outputting the reference image 64 which is read out therefrom in synchronization with acquisition of the inspection image to the comparator 53 in the pattern inspection and comparing the inspection image 72 with the grayscale reference image 64.

In preparation of the binary reference image of FIG. 5, the rounding operation may be performed on the binary reference image after rasterization. As a method of rounding, for example, the above-discussed technique disclosed in Japanese Examined Patent Application Laid Open Gazette No. 4-10565 (Document 1) can be used, and the disclosure of which is herein incorporated by reference. Specifically, the pixel values of the binary reference image are sequentially specified and assuming that there is a square area consisting of (N×N) (N is an odd number) pixels around the specified pixel, the sum of a plurality of pixel values of four sides of the area is compared with a predetermined value and the specified value is changed from 0 to 1 or from 1 to 0 in accordance with the comparison result, to thereby perform rounding on a corner portion of a pattern in the binary reference image.

In the pattern inspection apparatus 1, as another method of rounding on the binary reference image, the above-discussed technique disclosed in Patent Publication No. 2997161 (Document 2) can be used, and the disclosure of which is herein incorporated by reference. In this method, a dedicated binary mask pattern for detecting a corner of a pattern is prepared and the mask pattern is moved relatively to the binary reference image, and if all values of specified pixels in the mask pattern coincide with the values of the corresponding pixels in the reference image, the value of the pixel in the reference image corresponding to the central pixel of the mask pattern is changed from 0 to 1 or from 1 to 0. It is thereby possible to perform appropriate rounding of a corner portion of a pattern in the binary reference image.

Next, another exemplary operation for generating a grayscale reference image will be discussed. When this operation is adopted, the above-discussed operation for acquiring parameters for generation of a grayscale image is not performed.

First, the reference image compressed data 82 is outputted from the storage part 51 to the grayscale image generator 52 and expanded in real time, and binary reference image data is acquired in a form of raster data (Step S31 of FIG. 10). In the grayscale image generator 52, for example, when it is intended to generate a reference image of 256 levels ranging from 0 to 255 by quantizing a binary reference image into 8 bits, the pixel values of the binary reference image, i.e., 0 and 1, are converted into pixel values of 0 and 255, respectively. Subsequently, the binary reference image is divided into a plurality of divided areas, and a mean value of a plurality of pixel values included into each divided area is calculated. Each divided area is regarded as one pixel whose value is its mean value, and a grayscale intermediate image is generated in accordance with the reading resolution of the image acquisition part 33 (Step S32). Each divided area may be converted into an area consisting of two or more pixels having the same value to generate the intermediate image, and as discussed above, the grayscale image generator 52 substantially replaces a plurality of pixel values included in each of a plurality of divided areas with one grayscale pixel value which is obtained from the pixel values, to thereby generate the intermediate image.

The grayscale image generator 52 further performs the operation for generating a grayscale reference image by approximating the histogram of pixel values of the intermediate image to the histogram of the pixel values of the inspection image (Step S33). As a method for this operation, for example, the above-discussed technique disclosed in Japanese Patent Application Laid Open Gazette No. 2003-65969 (Document 6), and the disclosure of which is herein incorporated by reference.

Specifically, a histogram of the pixel values of the intermediate image and a histogram and a cumulative histogram of the pixel values of the inspection image are generated, and the upper limit value and the lower limit value of the pixel values are obtained from the cumulative histogram to select a desired pixel value range. Subsequently, the values of the pixels in the intermediate image are changed so that the selected pixel value range in the intermediate image should coincide with the selected pixel value range in the inspection image, and a grayscale reference image is thereby generated, where the histogram of its pixel values is approximated to the histogram of the pixel values in the inspection image.

After the grayscale reference image is generated, a smoothing filter is used for the grayscale reference image in accordance with change in pixel value in a direction perpendicular to an edge of a pattern in the inspection image, and the final reference image 64 is acquired (Step S34). With the above operation, the pattern inspection apparatus 1 can achieve an appropriate and steady generation of the grayscale reference image and perform an inspection of a very small pattern on the substrate 9 on the basis of the design data 81 with high accuracy.

There may be a case where the intermediate image is divided into a plurality of divided areas, a histogram is generated for each divided area and the pixel values of the intermediate image are converted by the divided area so that the histogram should be approximated to a histogram for the corresponding area in the inspection image. There may be another case where part of an inspection area is prescanned and a reference image is generated from the intermediate image so that a histogram for part of an inspection image acquired by the prescan should be approximated to a histogram for the corresponding area in the intermediate image. Specifically, in the grayscale image generator 52, with a variety of methods, the grayscale reference image may be generated from the intermediate image by approximating the histogram of the pixel values in the whole area or a partial area of the intermediate image to the histogram of the pixel values in the corresponding area of the inspection image.

Though the preferred embodiment of the present invention has been discussed above, the present invention is not limited to the above-discussed preferred embodiment, but allows various variations.

The image pickup of the luminous part 35 is not necessarily performed by the TDI line camera 36 but may be performed by a camera in which no electric charge is transmitted between light receiving elements (e.g., a general-type two-dimensional CCD) or the like. The electrons from the object (substrate) which are used for acquisition of the inspection image in the pattern inspection apparatus 1 are not limited to the secondary electrons or reflected electrons but any electrons can be used only if the electrons include information on a pattern on the object, and in the other words, the electrons are derived (directly or indirectly) from the object to acquire the inspection image. For example, backscattering electrons may be used, or transmission electrons which can be used when the image pickup part is put on the object may be used, to acquire the inspection image. Mirror electrons (a kind of reflected electrons) may be used, which are obtained by applying a reverse electric field in the vicinity of the object and reversing those orbit before collision with the object.

If it is not necessary to perform a pattern inspection at a high speed, the functions of the grayscale image generator 52 and the comparator 53 may be implemented by software.

The pattern inspection apparatus 1 is suitable for an inspection of a pattern which is formed of a multilayer film layered on a semiconductor substrate, but it can be used for an inspection of a pattern formed on, e.g., a printed circuit board or an exposure mask.

While the invention has been shown and described in detail, the foregoing description is in all aspects illustrative and not restrictive. It is therefore understood that numerous modifications and variations can be devised without departing from the scope of the invention.

This application claims priority benefit under U.S.C. Section 119 of Japanese Patent Application No. 2004-135054 filed in the Japan Patent Office on Apr. 30, 2004, the entire disclosure of which is incorporated herein by reference.

1. An apparatus for inspecting a pattern on an object, comprising:
an electron beam emission part for emitting an electron beam with which an object is irradiated;
an image acquisition part for acquiring a grayscale inspection image of an object by detecting electrons from said object;
a storage part for storing design data of a pattern formed on an object;
an image generation part for generating a grayscale reference image on the basis of said design data; and
a comparator for comparing a grayscale inspection image acquired by said image acquisition part with a grayscale reference image generated by said image generation part.

2. The apparatus according to claim 1, wherein
said electron beam emission part emits an electron beam onto the whole image pickup area on an object, and
said image acquisition part comprises
an optical system for forming an image with an electron beam from said image pickup area; and
an image pickup part for picking up an electron image at a position where an image is formed by said optical system to acquire said grayscale inspection image.

3. The apparatus according to claim 1, wherein
said image generation part generates said grayscale reference image by multivaluing a binary reference image derived from said design data on the basis of a histogram of pixel values of said grayscale inspection image.

4. The apparatus according to claim 3, wherein
said image generation part sets a plurality of pixel value ranges on the basis of said histogram and generates an intermediate image which is obtained by converting pixel values of 0 and 1 in said binary reference image into representative values in two pixel value ranges which correspond to both ends of said histogram, and then generates said grayscale reference image on the basis of said intermediate image.

5. The apparatus according to claim 4, wherein
said image generation part divides said intermediate image into a plurality of divided areas and substantially replaces values of a plurality of pixels included in each of said plurality of divided areas with one value obtained from said values of said plurality of pixels.

6. The apparatus according to claim 3, wherein
said image generation part divides said binary reference image into a plurality of divided areas and generates an intermediate image which is obtained by substantially replacing values of a plurality of pixels included in each of said plurality of divided areas with one grayscale pixel value obtained from said values of said plurality of pixels, and further generates said grayscale reference image from said intermediate image by approximating a histogram of pixel values in the whole area or a partial area of said intermediate image to a histogram of pixel values in the corresponding area of said grayscale inspection image.

7. The apparatus according to claim 1, wherein
said image generation part smoothes said grayscale reference image in accordance with change of pixel value in a direction perpendicular to an edge of a pattern in said grayscale inspection image.

8. The apparatus according to claim 1, wherein
said object is a substrate on which a multilayer film is formed.

9. The apparatus according to claim 1, wherein
said object is a semiconductor substrate.

10. A method of inspecting a pattern on an object, comprising the steps of:
a) emitting an electron beam onto an object;
b) acquiring a grayscale inspection image of said object by detecting electrons from said object;
c) generating a grayscale reference image on the basis of design data of a pattern formed on said object; and
d) comparing said grayscale inspection image with said grayscale reference image.

11. The method according to claim 10, wherein
an electron image is picked up with an electron beam from an image pickup area on said object in said step b).

12. The method according to claim 10, wherein
said grayscale reference image is generated by multivaluing a binary reference image derived from said design data on the basis of a histogram of pixel values of said grayscale inspection image in said step c).

13. The method according to claim 12, wherein
a plurality of pixel value ranges are set on the basis of said histogram and an intermediate image is generated by converting pixel values of 0 and 1 in said binary reference image into representative values in two pixel value ranges which correspond to both ends of said histogram, and then said grayscale reference image is generated on the basis of said intermediate image in said step c).

14. The method according to claim 13, wherein
said intermediate image is divided into a plurality of divided areas and values of a plurality of pixels included in each of said plurality of divided areas are substantially replaced with one value obtained from said values of said plurality of pixels in said step c).

15. The method according to claim 12, wherein
said binary reference image is divided into a plurality of divided areas and an intermediate image is generated by substantially replacing values of a plurality of pixels included in each of said plurality of divided areas with one grayscale pixel value obtained from said values of said plurality of pixels, and said grayscale reference image is further generated from said intermediate image by approximating a histogram of pixel values in the whole area or a partial area of said intermediate image to a histogram of pixel values in the corresponding area of said grayscale inspection image in said step c).

16. The method according to claim 10, wherein
said grayscale reference image is smoothed in accordance with change of pixel value in a direction perpendicular to an edge of a pattern in said grayscale inspection image generated in said step c), before said step d).

17. The method according to claim 10, wherein
said object is a substrate on which a multilayer film is formed.

18. The method according to claim 17, wherein
said object is a semiconductor substrate.
